(19) United States
(12) Patent Application Publication
(10) Pub. No.: US 2024/0273654 A1
(43) Pub. Date: Aug. 15, 2024

(54) Creation of a Private Market and Marketplace for Cooking Recipes on Blockchain

(71) Applicant: Balaji Kannaiyan, Cary, NC (US)

(72) Inventor: Balaji Kannaiyan, Cary, NC (US)

(21) Appl. No.: 18/167,849

(22) Filed: Feb. 11, 2023

(51) Int. Cl. G06Q 50/12; G06Q 20/38

(52) U.S. Cl. CPC G06Q 50/12; G06Q 20/389

(57) ABSTRACT

Creation of new private markets for cooking recipes and restaurants on the blockchain. The private market allows the creation of a new marketplace where chefs, recipe creators, cookbook authors, influencers, restaurants, and meal delivery services can trade their services without a middleman. The private market creates a new market mechanism to make this asset and service transaction possible. As a consequence of the private market, this invention claims a new marketplace is created where the assets and services are transacted thru various smart contracts. As a consequence of the new transaction mechanism, this invention claims that a new category of distributed and autonomous restaurants and delivery services is created that is NFT-enabled and AI-enabled distributed smart social restaurants.

This application claims priority from the benefit of provisional patent application Ser. No. 63/267,898, filed on Feb. 11, 2022, by the present inventor.

### SUMMARY

In accordance with one embodiment of the system and methods to create a private market and marketplace for cooking recipes on the blockchain, a new possibility is created for distributing, owning, sharing, and experiencing digital content in a personalized way and experiencing and consuming it offline as well. This new horizon redefines online and offline experiences for every stakeholder in the ecosystem.

### Advantages:

Accordingly, several advantages of one or more are as follows:
A new private market to tokenize various—offline assets comprising of recipes, videos, blogs, technical know-how, cookbooks, menus, physical restaurants in a location, virtual restaurants in the metaverse, and online digital restaurants—and convert them into crypto assets.
A new marketplace to transact crypto assets that enhance the revenue potential of every stakeholder and improves customer satisfaction of customers. Personalization of the marketplace affords us a significant leap in the possibilities of various services that can be offered in this marketplace. Personalization offers the ability to create a unique experience for the customer and a set of customers.
A new co-pilot engine that manages the personalization of content to customers and the personalization of content to restaurants through recipes and menus is a new horizon in meal delivery services. This could not have been possible before without the latest breakthroughs in artificial intelligence.
A new kind of distributed restaurant is possible because of all these technological breakthroughs to create new kinds of restaurants comprising NFT-enabled restaurants, AI-enabled restaurants, and AI-enabled and NFT-enabled meal delivery services, smart social restaurants.

### DRAWINGS—FIGURES

In the drawings, closely related figures and methods have the same first digit, and the second and third digits refer to the steps related to the first digit.

FIG. 1—System and method to create a new private market and marketplace for cooking recipes on the blockchain.

FIG. 2—Creation of new crypto private market

FIG. 3—Creation of new NFT marketplace

FIG. 4—Creation of co-pilot for distributed restaurants

FIG. 5—Method to tokenize contents/recipes/menus

FIG. 6—Method to tokenize restaurants

FIG. 7—Method to tokenize discovery of services and restaurants

FIG. 8—Method to discover personalized content for the audience

FIG. 9—Method to discover operational intelligence

FIG. 10—Method to create co-pilot for distributed restaurants

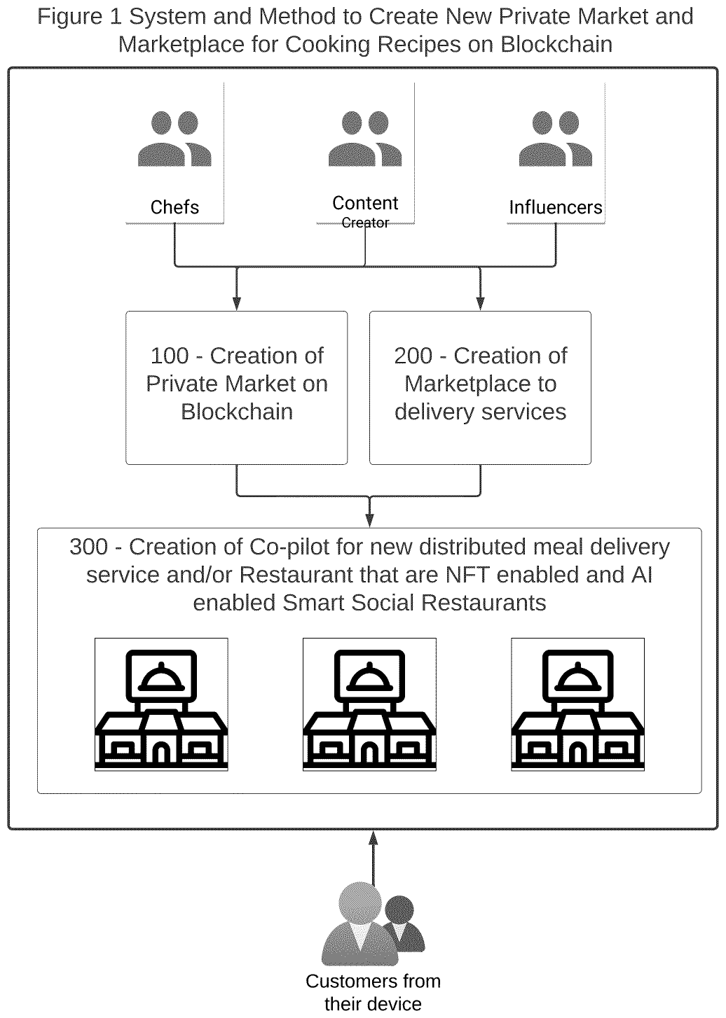

### DETAILED DESCRIPTION—FIG. 1—FIRST EMBODIMENT

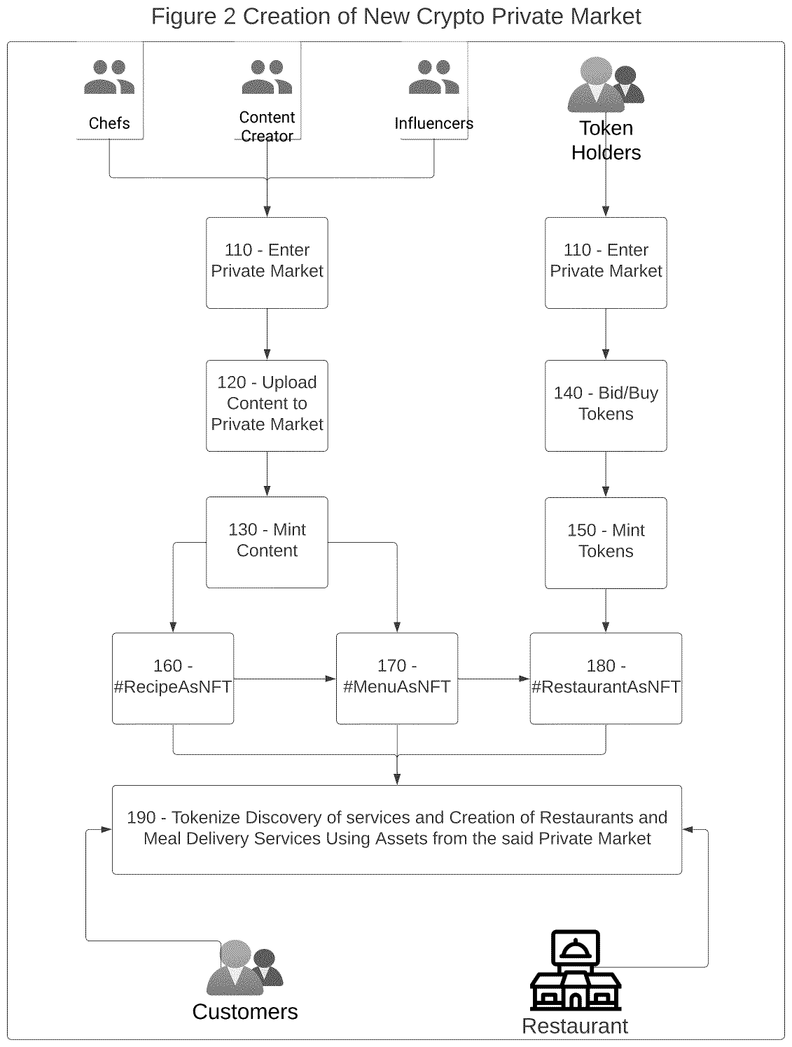

The system and method to create a new private market and marketplace for cooking recipes on the blockchain are shown in FIG. 1. The private market, as shown in FIG. 1, step 100, creates a new kind of marketplace to deliver new kinds of services shown in FIG. 1 and step 200. New kinds of services that are created from the said marketplace help to create new kinds of distributed meal delivery services and restaurants shown in FIG. 2 and step 300.

The private market, shown in FIG. 1, step 100, allows chefs, recipe creators, cookbook authors, influencers, restaurants, and meal delivery services can trade their services without a middleman.

As a consequence of the private market, shown in FIG. 1, step 100, allow the creation of a new marketplace, shown in FIG. 1, step 200. This new marketplace allows assets and services to be transacted thru various smart contracts.

This new transaction mechanism allows new kinds of assets and new kinds of services in the marketplace shown in FIG. 1, step 200.

As a consequence of the new transaction mechanism, a new category of distributed and autonomous restaurants and delivery services are created, as shown in FIG. 1, step 300.

This new transaction mechanism creates a new king of NFT-enabled and AI-enabled restaurants and delivery services.

As a consequence of the system and method shown in FIG. 1, consumers can access the entire capabilities of this new intention from their devices.

### Detailed Description—FIG. 2—Second Embodiment

FIG. 2 shows the system for creating a new crypto private market.

In the private market, the stakeholders comprising of chefs, content creators, cookbook authors, and influencers, can enter this market and upload content comprising of videos, blogs, and cookbooks and converts them into recipes and menus as new crypto assets. FIG. 2 shows this process in steps 110, 120, and 130.

In the private market new class of crypto assets comprised of the recipe as NFT and menu as shown in FIG. 2, steps 160 and 170.

In the private market, a new class of crypto assets comprising physical restaurants are tokenized, as shown in FIG. 2, step 180. Tokenization of crypto assets is built on a unique process of the bid/buy model—which is modeled based on various token economics as shown in FIG. 2, step 140. Consumers who want to know token in the restaurants can access the private market and bid/buy tokens that are minted for the restaurant, as shown in FIG. 2, step 110, 140, and 150. This creates a new asset class comprising restaurants as NFT, as shown in FIG. 2, step 180.

In the private market, the tokenization of assets creates new services that are discovered through discovery services, as shown in FIG. 2 and step 190. This service discovers customers, stakeholders, and distributed restaurants and matches various services offered on the private market.

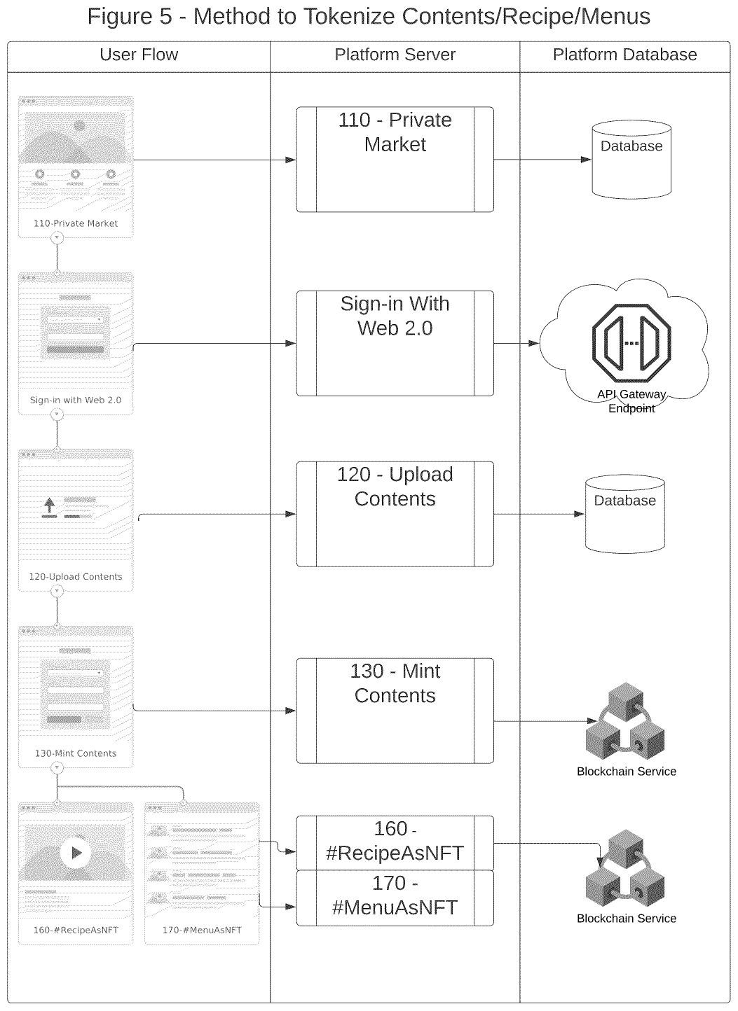

### Operation—FIG. 5

FIG. 5 shows the method for tokenizing content, recipes, and menus.

Step 110—Allows stakeholders comprising chefs, content creators, cookbook authors, and influencers to enter the market to create a new crypto asset class.

Step 120—Allow the stakeholders to upload the content and convert all the offline content and online (web 2) content into the platform server, which intern stored in the platform database.

Step 130—Allow the contents to be minted on any blockchain platform and get their address back on the platform server and stored in the user's wallet.

Step 160—Allow the minted contents to be created as non-fungible tokens (NFT) or fungible tokens through various smart contracts and publish it as a recipe as NFT on blockchain services and NFT marketplaces.

Step 170—Allow the minted contents to be created as non-fungible tokens (NFT) or fungible tokens through various smart contracts and publish it as Menu as NFT on the blockchain services and NFT marketplaces.

These steps in the method create a new web 3.0 asset class and take ownership of the assets, which was not possible before.

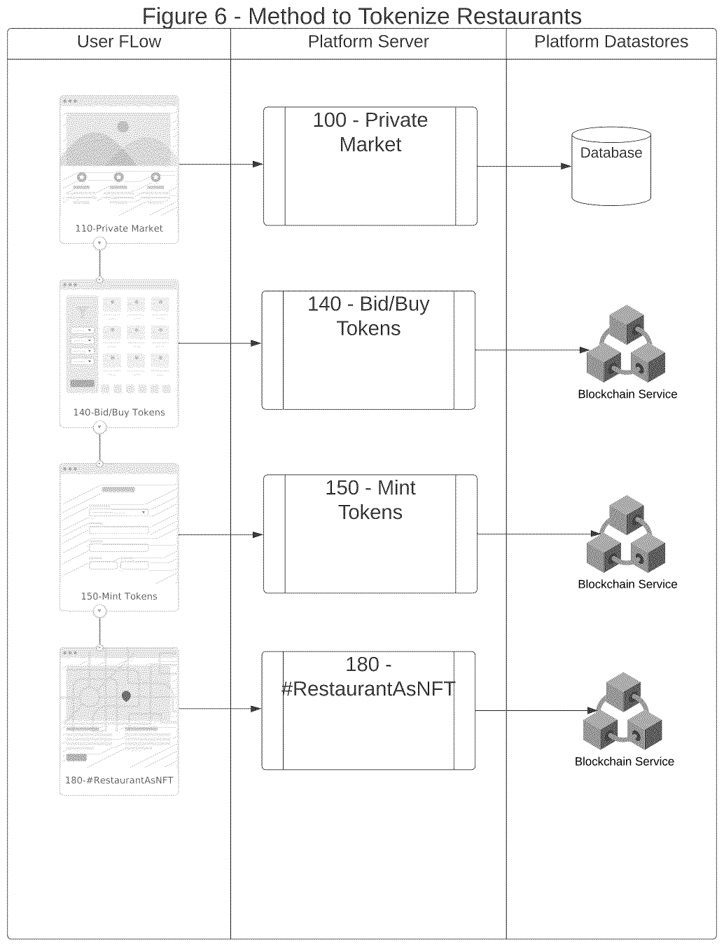

### Operation—FIG. 6

FIG. 6 shows the method to tokenize physical restaurants.

Step 110—The private market allows future token holders to enter the private market.

Step 140—In the private market, a new unique model is created to bid and buy tokens that are created based on discovery services and matched by an artificial intelligence engine.

Step 150—In the private market, new tokens are minted for the restaurants and shown on all blockchain services.

Step 180—In the private market, physical restaurants are converted as NFT.

Creation of restaurants as NFT enhances the utility of physical restaurants and makes it possible to run autonomous restaurants. DAOs are created to incentivize the autonomous behavior of restaurants.

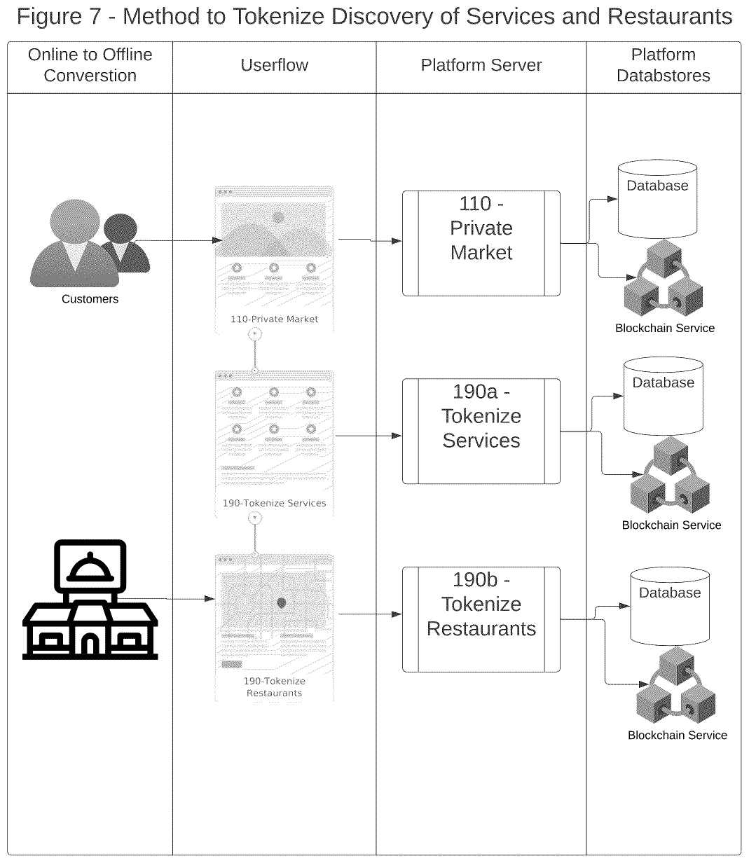

### Operation—FIG. 7

FIG. 7 shows the method to tokenize the discovery of new services and new kinds of restaurants and meal delivery services.

Step 110—As a consequence of the private market, shown in FIG. 7, step 110, new crypto assets such as #RecipeAsNFT and #MenusAsNFT, new capabilities are available to run distributed restaurants possible.

Step 190a—Shows discovery of new services:
A. A new method to package recipe and menu NFTs using generative AI technology to personalize the contents to customers.
B. A new method where customers can request meals based on recipeAsNFT and menuAsNFT contents
C. A new method to distribute the customer's request without any manual intervention to any distributed restaurant that is executed through smart contracts.
D. A new method to tokenize contents that are discovered by AI engines to individual customers.

Step 190b—Shows the tokenization of restaurant services:
A. A new method to create meals based on NFT recipes and NFT menus that are personalized without human intervention through the execution of smart contacts.
B. A new method to lease recipes and menus from content creators and pay appropriate royalty.
C. A new method to get access to the contents that are in demand in the marketplace.
D. A new method to get access to the contents that are discovered by an artificial intelligence engine
E. A new method to create exclusivity of content to a specific set audience
F. A new method to run restaurant operations autonomously with AI engine and incentive tokens like NFTs and DAO.

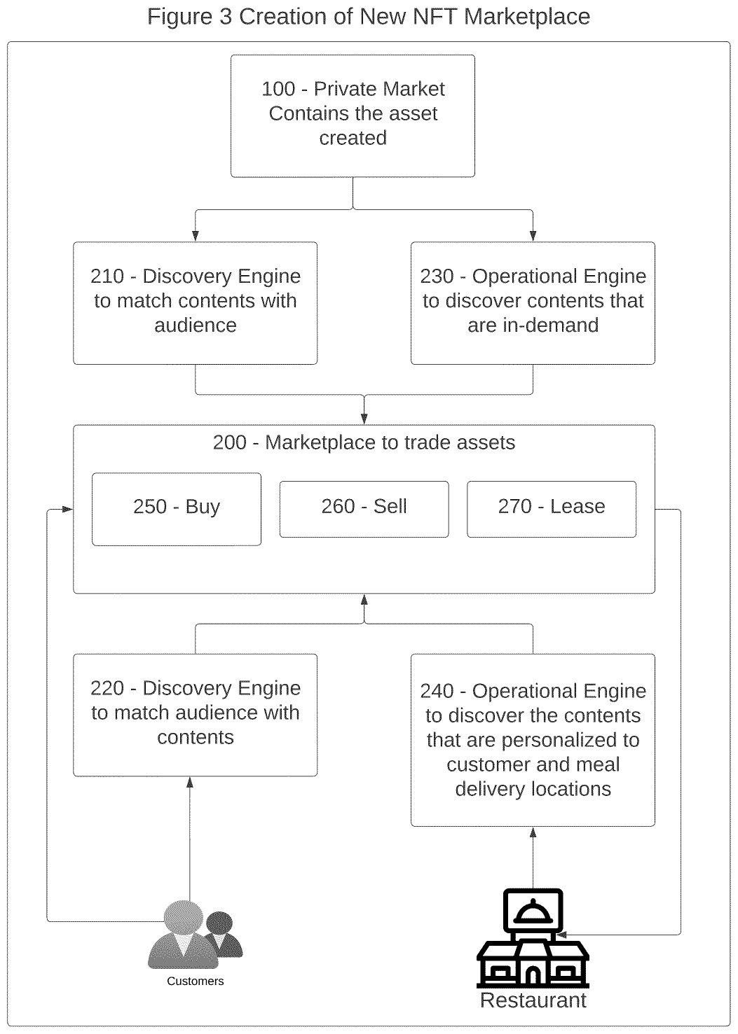

### Detailed Description—FIG. 3—Third Embodiment

FIG. 3 shows the systems and methods to create a new NFT marketplace from the newly created crypto private market shown in FIG. 1, step 100.

The marketplace is the hub that connects the private market and distributed meal delivery services. Discovery engines power the marketplace to match every stakeholder in the multisided marketplace.

An AI-powered discovery engine is created to match content with the audience, as shown in FIG. 3, step 210. Another AI-powered discovery engine is created to find an audience for the content creator and various stakeholders, as shown in FIG. 3, step 220. These two engines match and personalize content in the marketplace for customers and other stakeholders.

Based on the recommendations from the discovery engine, customers can buy crypto assets from the marketplace, as shown in FIG. 3, step 250.

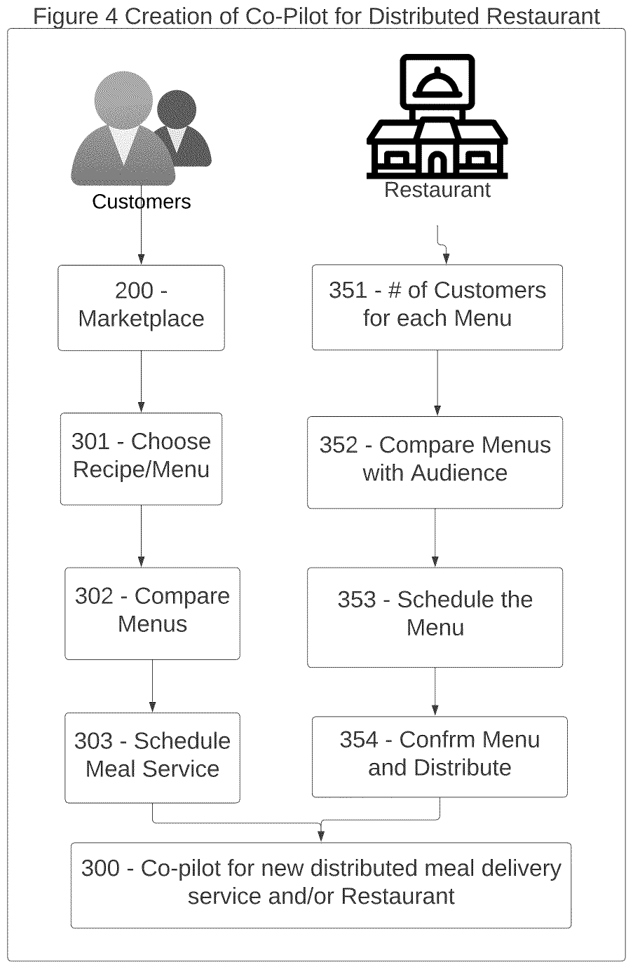

Based on the recommendations from the discovery engine, content creators, chefs, and influencers can sell crypto assets on the marketplace, as shown in FIG. 4, step 260.

Based on the recommendations from the discovery engine, distributed restaurants can lease the contents and know-how from the marketplace, as shown in FIG. 3, step 270, and pay royalties to the creators.

These discovery engines, which are the backbone of the marketplace, personalize the discovery and distribution of content to various stakeholders in the marketplace.

As a consequence of this personalization, another AI-powered operational engine is created to discover in-demand content in the marketplace, as shown in FIG. 3, step 230.

As a consequence of this personalization and discovery of in-demand content, another new AI-powered operational engine is created to run the discovery of distributed restaurants that can allow consumers to experience the meal service that they want. This is a new horizon that was not possible before. This is a new immersive experience that integrates online experience to offline experience. Online can be the internet, metaverse, on any other AR/VR medium.

This marketplace can extend to any medium on the internet, comprising social media, blogs, websites, and the metaverse.

As a consequence of this marketplace extension, customers can buy content through any new channels, as shown in FIG. 3, step 250.

As a consequence of this marketplace extension, chefs, content creators, and influencers can sell content through new channels, as shown in FIG. 3, step 260.

As a consequence of this marketplace extension, distributed restaurants can lease the contents from any new channels and pay royalty, as shown in FIG. 3, step 270.

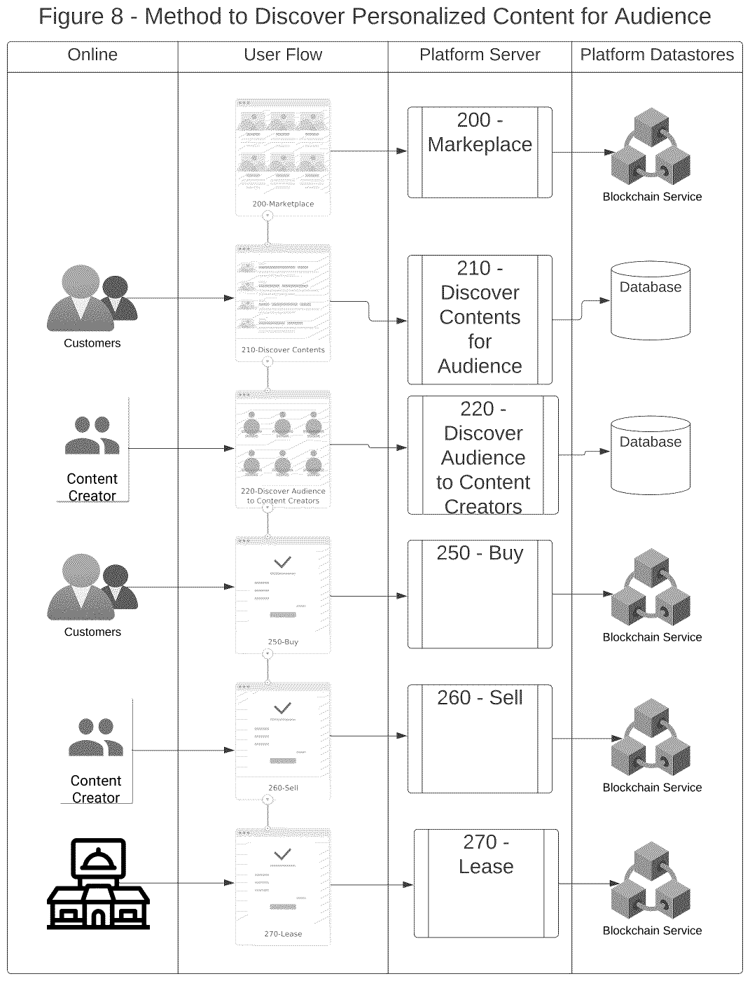

### Operation—FIG. 8

FIG. 8 shows the method to discover personalized content for the audience.

Step —200 shows the NFT marketplace on the blockchain.

Step —210 shows the discovery engine that runs to match content to the audience from the various constraints in the platform server and platform data stores.

Step —220 shows the discovery engine to match the audience to content creators based on the various metrics and constraints in platform servers and platform data stores.

Step —250 shows recommendations that the discovery engine has produced and customers who can buy the contents from any online medium.

Step —260 shows recommendations audience that the discovery engine has discovered for content creators and chefs and sells the content to any online medium.

Step —270 shows recommendations to distributed restaurants to know what customers are looking for and lease the contents from the marketplace and pay the royalty to owners of the content.

As a consequence of this method, personalized distribution of contents is achieved that has not been done before.

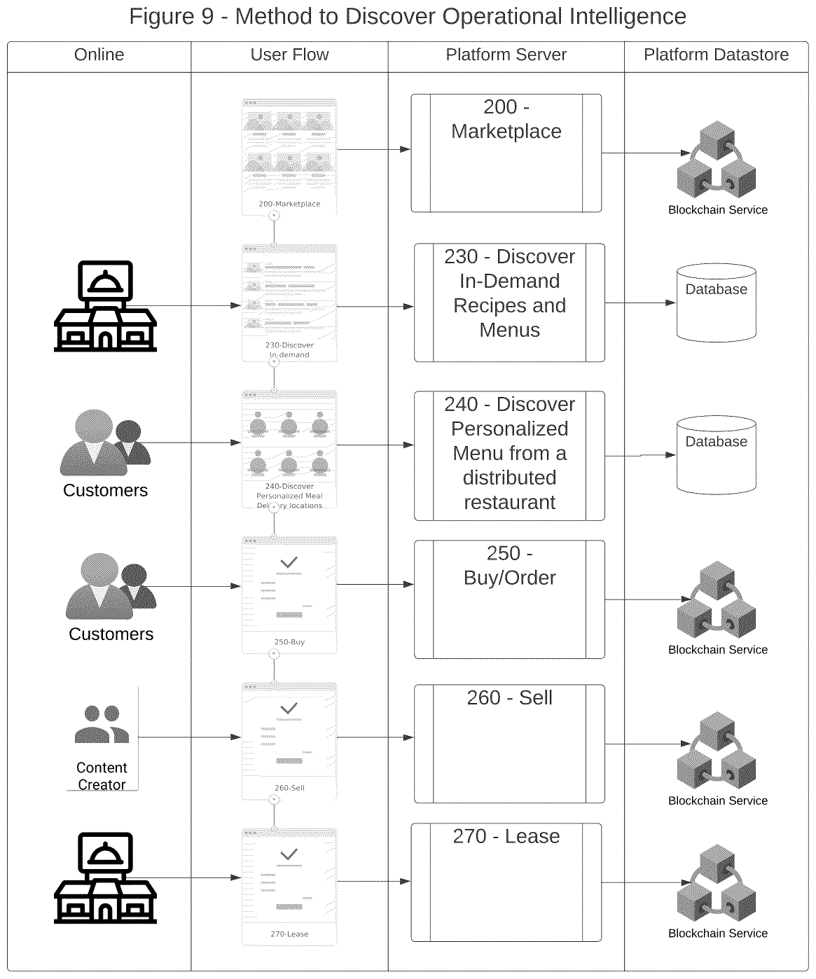

### Operation—FIG. 9

FIG. 9 shows the method to discover operational intelligence for distributed meal service comprising restaurants.

Step 200—shows the NFT marketplace on the blockchain.

Step 230—shows the discovery of operational intelligence to run distributed restaurants comprising in-demand recipes and menus.

Step 240—shows the discovery of operational intelligence to run distributed restaurants comprising personalized recipes and menus for the distributed restaurant.

Step 250—shows the recommendations to the customers that are available and that were discovered by operational intelligence in the distributed restaurants that can be bought/ordered.

Step 260—shows the recommendations to the content creators that the audience wants and that were discovered by operational intelligence in the distributed restaurants that can be sold to the marketplace.

Step 270—shows the recommendations to distributed restaurants that the audience wants and that were discovered by operational intelligence that can be leased and appropriate royalty paid back to creators.

As a consequence of this method, new operational intelligence is created based on the discovery of a personalization engine and operational engine. This creates a new horizon for customer experience.

### Detailed Description—FIG. 4—Fourth Embodiment

FIG. 4 shows the system and method for creating a co-pilot to run distributed restaurant.

Co-pilot connects the discovery services of the private market and marketplace, as shown in FIG. 1, step 300. Co-pilot is the operational intelligence to run distributed restaurants.

Co-pilot gathers requirements from the personalization services and distributes the customers' needs to distributed restaurants. This new horizon replaces all the old discovery services comprising yelp reviews, google Maps reviews. This new horizon directly connects customers to chefs and cooks in the distributed restaurants by bypassing all intermediaries. This new horizon brings the best customer experience to restaurants and meal delivery services.

Customers can choose their choice of recipes and menus to be cooked by the distributed restaurants, as shown in FIG. 4, step 301.

Customers can compare the recipes and menus and choose the one they like from their recommended choices, as shown in FIG. 4, step 302.

Customers can schedule meals based on the choices of a given location of restaurants generated by an artificial intelligence engine, as shown in FIG. 4, step 303.

Distributed restaurants can see the number of customers for each set of menus, as shown in FIG. 4, step 351.

This allows chefs, cooks, and managers to decide which menu to choose for their restaurants that can increase the profit margin, as shown in FIG. 3, step 352.

The chosen menu is scheduled to kick off the back office integrations for the menu, as shown in FIG. 4, step 353.

The confirmed menu is distributed to the co-pilot to send notifications to all customers, as shown in FIG. 4, step 354.

Co-pilot manages the operational intelligence of this process and moves the horizon of new customer experience.

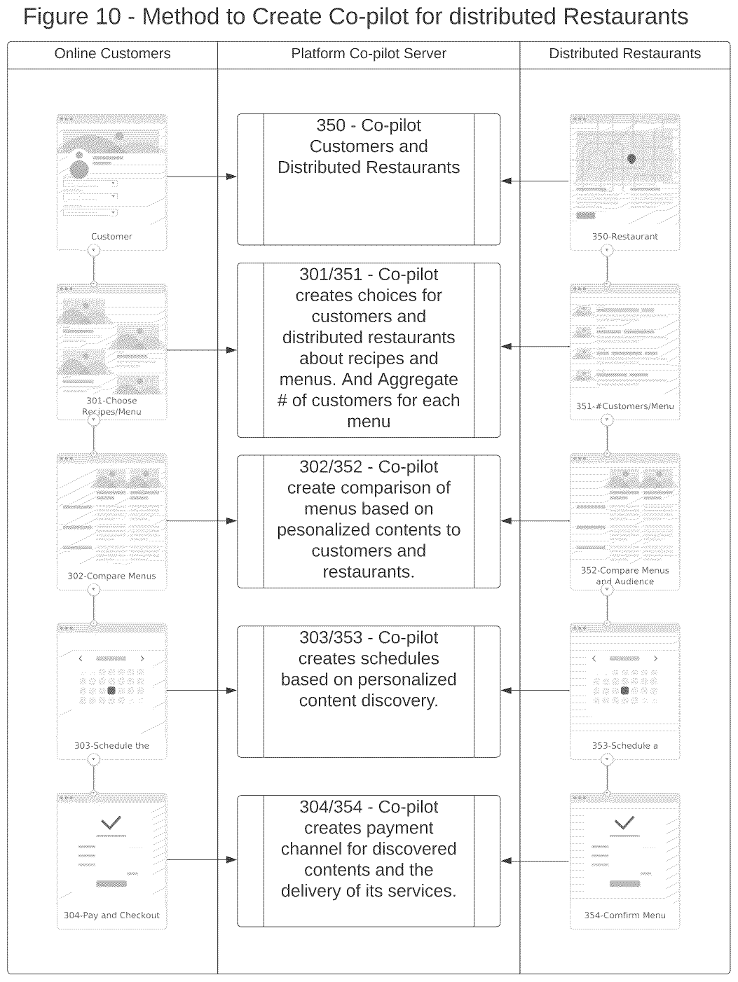

### Operation—FIG. 10

FIG. 10 shows the method to create a co-pilot for distributed restaurants and connects it to the customers based on the discovery services from the marketplace.

Step 350—shows the creation of a co-pilot where customers and distributed restaurants work in unison the fulfill the needs of customers.

Step 301/351—shows the creation of choices for customers and distributed restaurants. For costumes, it shows the personalized recipe and menu recommendation list of their choices. For restaurants, it shows the number of customers available for each recipe and menu. This helps chefs and cooks choose the best menu for them.

Step 302/352—shows the comparison recipe and menu choices for customers and distributed restaurants. For customers, the recipe and menu comparison is based on their personalized preferences. Distributed restaurants show recipe and menu comparisons based on the operational intelligence of the co-pilot.

Step 303/353—shows the ability to schedule for customers and distribute restaurants. For customers, it gives them the ability to choose a time and place to experience their choice the menu. For restaurants, it gives the ability to schedule the menu for the appropriate day.

Step 304/354—shows the ability to pay for the service for the customers. For restaurants, it shows the ability to receive payment through various channels.

The execution excellence of this distributed operation is achieved through the operations intelligence of the co-pilot.

### Advantages:

From the description above, a number of advantages of the embodiments of my creation of a private market for cooking recipes on the blockchain become evident:
A new private market to tokenize various—offline assets comprising recipes, videos, blogs, technical know-how, cookbooks, menus, physical restaurants in a location, virtual restaurants in the metaverse, and online digital restaurants—and convert them into crypto assets.
The private market creates a new possibility of distributing, owning, sharing, and experiencing online and offline content—briefly abbreviated as DOSE—Distribute-Own-Share-Experience.
A new marketplace to transact crypto assets that enhance the revenue potential of every stakeholder and improves customer satisfaction of customers. Personalization of the marketplace affords us a significant leap in the possibilities of various services that can be offered in this marketplace. Personalization offers the ability to create a unique experience for the customer and a set of customers.
The marketplace offers a means to provide personalized distribution, ownership, sharing, and experience to offline and online content—briefly abbreviated as Personalized DOSE—Personalized Distribute-Own-Share-Experience
A new co-pilot engine that manages the personalization of content to customers and the personalization of content to restaurants through recipes and menus is a new horizon in meal delivery services. This could not have been possible before without the latest breakthroughs in artificial intelligence.
A new creation of a co-pilot for autonomously run operations intelligence for customers and distributed restaurant or meal delivery place is a new frontier in the distribution of last-mile experiences to customers and restaurants. This creates a new operational pipeline to connect customers to restaurants' bottom line.
A new kind of distributed restaurant is possible because of all these technological breakthroughs to create new kinds of restaurants comprising NFT-enabled restaurants, AI-enabled restaurants, and AI-enabled and NFT-enabled meal delivery services, smart social restaurants.
A new category of tokenized restaurants that run autonomously with various incentive mechanisms, like NFTs and DAOs, pushes the new frontiers of how restaurants are financed, marketed, and operated.

### CONCLUSION

Accordingly, the reader will see that creating private markets for cooking recipes on the blockchain, shown in the above embodiment—FIG. 1, creates a new crypto asset class. Creating a new crypto asset class on the private market gives an opportunity to create a new marketplace to trade crypto assets and personalize the distribution, own, share, and experience the online and offline behavior in a new way that was never done before. The discovery services of the private market and marketplace create a new co-pilot that embodies the operational intelligence of all stakeholders. The operational intelligence of the co-pilot creates a new category of distributed restaurants that are NFT-enabled, AI-enabled, smart social restaurants. This is the new horizon to experience the magic of all these technologies working seamlessly to create and run an autonomous organization without human intervention.

I claim:

1. A method to create a private market for cooking recipes as a means to create a new assets class that never existed before comprising of:
a. As a non-fungible-token (NFT)
b. As a fungible token
c. Distributing the contents to token holders
d. Distributing the content to meal delivery services comprising restaurants

2. A method to convert contents comprising of:
a. Videos
b. Blog
c. Cookbooks
d. Website recipe collections
e. Handwritten notes
f. Offline restaurants recipes and menus

3. A method to tokenize recipes means a new asset class is created as #RecipesAsNFT that never excited before:
a. That credits the owner of the creation with the rights to sell and lease the assets

4. A method to tokenize secrets and deep professional know-how mean that the said know-how can be delivered to the person who has appropriate crypto addresses and therefore have access to:
a. Secrets and know-hows as #SecrectsAsNFT
b. Use the secrets and know-how to use in the operations of distributed digital restaurants

5. A method to tokenize the menu means a new asset class is created that did not exist before where:
a. Chefs, Content Creators, Influencers, Consumers, and Restaurants can create a new asset class as #MenuAsNFT
b. The said artificial intelligence engine can create a new asset class as #MenuAsNFT
c. The said co-pilot discovery services can create a new asset class as #MenuAsNFT

6. A method to tokenize the creation of new meal delivery services means
a. A method to create a new category of digital restaurants that never existed before
b. A method to create a new category of NFT-enabled enabled restaurants that never existed before
c. A method to create a new category of AI-enabled restaurants that never existed before

7. A method to tokenize the meal delivery services means:
a. A method to create meals based on NFT recipes and NFT menus that get executed through the use of smart contracts with human intervention. This capability never existed before with human intervention.
b. A method to package the contents based on the recommendations of the AI engine to create various meal services.

8. A method to tokenize assets of meal delivery services means:
a. A method to borrow recipes and ideas from some and use that idea to deliver meal service based on the content available in the private market
b. A method to request recipes and menus that customers like to be cooked by distributed meal delivery services

9. A method to tokenize consumer access to meal delivery services means:
a. A new method to create utility tokens that give access to the contents that the artificial engine discovers for the individual customers

10. A method for tokenization of exclusivity means:
a. A new method to issue utility tokens to gain access to distributed meal services comprising restaurants.

11. A method to tokenize autonomous operations of distributed meal delivery services comprising restaurants means:
a. A method to create DAO services to run meal services autonomously
b. A method to create incentive tokens to run meal services autonomously

12. A method to create an online Marketplace means:
a. A method to create a new service to buy the new asset class created in the private market that never existed before
b. A method to create a new service to sell the new assets class created that creates a new revenue stream for creators
c. A method to create a new service to lease the new asset class created in the private market and collect a royalty

13. A method to create a discovery engine to match contents with the audience means:
a. A method to create a new artificial intelligence engine to discover content for the audience related to recipes, menus, locations, collections

14. A method to create a discovery engine to match the audience with content means:
a. A method to create a new artificial intelligence engine to discover the audience for content and content creators

15. A method to buy discovered assets means:
a. A new method to buy the said discovered assets

16. A method to sell assets means:
a. A new method to sell their own content and know-how to the marketplace

17. A method to lease means:
a. A new method to lease the contents and collect a royalty

18. A method to create an operational artificial intelligence engine means:
a. A method to discover the in-demand content comprising recipes, menus
b. A method to personalize the content for customers
c. A method to personalize the content to distributed delivery locations
d. A method to discover the contents that are personalized to customers and send it to distributed delivery locations

19. The creation of a co-pilot means for meal delivery services is:
a. A new category of distributed meal delivery services comprising restaurants is created
b. A new service that works to bring the right set of audience to the meal delivery services

20. A method to create a co-pilot means for customers is:
a. A method to create recommendations of recipes and menus based on the co-pilot engine for the customer
b. A method to create personalization services for the customers

21. A method to create a co-pilot means for recipes and menus is:
a. A method to compare recipes and menus based on their personalization
b. A method to compare the audience size for each set of recipes and menus by distributed meal delivery services

22. A method to create co-pilot means for the schedule is:
a. A method for customers to schedule meals to be experienced in meal delivery locations
b. A method for distributed meal delivery services to schedule the recipes and menu

23. A method to create co-pilot means for the confirmation of services is:
a. A method for customers to pay for their service in traditional payment channels and new crypto payment channels.
b. A method for distributed meal delivery services to confirm the menu and send customer notifications.
